(19) United States
(12) Patent Application Publication
(10) Pub. No.: US 2025/0250858 A1
(43) Pub. Date: Aug. 7, 2025

(54) SCREEN FABRIC RETENTION DEVICE WITH SLIP CLUTCH

(71) Applicant: Michael Heissenberg, Port St. Lucie, FL (US)

(72) Inventor: Michael Heissenberg, Port St. Lucie, FL (US)

(21) Appl. No.: 19/189,385

(22) Filed: Apr. 25, 2025

Related U.S. Application Data
(63) Continuation-in-part of application No. 18/166,105, filed on Feb. 8, 2023, now Pat. No. 12,312,862.

(51) Int. Cl. E06B 9/72; E06B 9/58; F16D 7/00

(52) U.S. Cl. CPC E06B 9/72; E06B 9/58; F16D 7/00

(57) ABSTRACT

A screen fabric retention device in the form of a motor and spring combination for a hurricane screen fabric. The combination overcomes the change in torque for use with a motor driven hurricane screen fabric system, allowing the motor to operate if there is a change in the initial torque which otherwise will interrupt motor operation. The device allows vertical deployment of screen fabric when the motor is idle, which prevents the base slat from lifting during high wind loads. A slip clutch assembly is attached to the drive end of the motor allows fabric deployment. The slip clutch will limit torque with the same force in both directions.

### PRIORITY CLAIM

This application is a continuation-in-part and claims a prior date based upon U.S. patent application Ser. No. 18/166,105 filed Feb. 8, 2023 entitled SPRING LOADED SCREEN FABRIC RETENTION DEVICE the contents of which is incorporated herein by reference.

### FIELD OF THE INVENTION

The present invention relates to the field of hurricane screen protection and, more particularly, to a rolling screen with an electric motor having a slip clutch for securing screen fabrics used in high wind environments.

### BACKGROUND OF THE INVENTION

Property protection is of paramount importance to property owners. Damage from high winds is preventable by covering openings, patios, the like structures that are susceptible to high winds. For instance, hurricane force winds can quickly breach an opening of a structure, resulting in extensive damage. Windows and doors, if pierced open by flying debris, place the entire structure at risk. Once winds are allowed inside a property, debris and wind changes the air pressure quickly and intensely. In an instance, the change in air pressure with wind accompaniment can lift the roof off the property. Covered patios are but another example of property areas that can be damaged if wind is able to get below the roof.

Roll up hurricane shutters are well known in their ability to prevent wind breaching. Roll up shutters provide excellent frangible area coverage and, once installed, can be deployed by simply drawing interconnected panels from a storage housing. The interconnected panels are difficult to breech, providing excellent security coverage that can be deployed by simply pulling the shutters from a shutter housing. In many instances, the use of screen fabrics have become a desirable alternative, as the screen fabric is less weight and easier to store. In many instances, the screen fabrics can be stored on site using a retractable system wherein screen fabric edges are fed through channels to provide securement without additional fasteners. For high winds, a screen fabric having a continuous edge attachment is more secure than a screen fabric having spaced apart fasteners. While screen fabrics allow some wind to pass, if rain is present, the water acts as a wind barrier wherein no wind can pass through the screen fabric. When this occurs, the screen fabric acts as a sail and subjects the fasteners to the highest possible pressures.

In certain instances, hurricane screen fabrics have become the choice of protection. For instance, when the area to be protected is large, use of a screen fabric may be the only practical option. A screen fabric can be rolled into a storage housing that is smaller in size than a shutter storage housing having similar length. Hurricane screen fabrics are the preferred articles for sunlight shading and insect blocking. A typical hurricane fabric installation consists of a screen storage housing containing a roll of hurricane screen fabric. In a common embodiment, the roll can be rotated for deployment or retraction of the screen fabric. A base slat is attached to the distal end of the screen fabric which is drawn to the floor, window or door sill and secured thereto using a track. A common problem with all known hurricane screen fabrics is that the base slat lifts off the floor in windy conditions. Reports indicate that the base slats may lift off the floor by several inches or completely pull out of the track in winds of only 30-40 mph.

Known hurricane screen fabric is formed from a fabric typically woven using two materials, a polymer in one direction and aramid (Kevlar) in the cross direction. This causes the fabric to stretch and billow in one direction only. In this configuration, when wind pressure is applied, the fabric is held firmly by the housing along the top and the tracks on either side. The screen fabric is essentially a wind block at higher wind speeds, placing the most pressure on the base slat. As a result, the fabric begins to lift the base slat off the floor. For instance, a 24 foot screen fabric unit will lift the base slat approximately two feet off the floor during a high wind event.

Various prior art references address ways of securing a screen fabric. U.S. Patent Publication 2006/0137836 discloses a sealing curtain assembly having a pair of tracks attached to opposite sides of an opening. Each track includes a spring system which urges the tracks outwardly to maintain the curtain taut. The spring system employs a connecting member, preferably a bolt, which allows the track edges to separate from a frame member. In one embodiment, a compression spring and washer are located between the head of each connecting member and track. A problem with the use of spring-loaded connecting members is that the spacing between each member provides an area for the screen fabric to bind between connecting members.

U.S. Pat. No. 8,607,841 discloses a screen fabric device having inner rails that are embedded inside fixed guide rails which guide protrusions at side edges of a screen fabric which is wound via a take-up shaft. Each inner rail has a guide groove in which the guide protrusion is inserted, and inward flanges are provided at an opening of the guide groove. Rail members have outer side protrusions and inner side protrusions of different heights at both side edges of a rail base plate. The higher outer side protrusions are confronting. A micro gap extends between the lower inner side protrusions into the guide groove such that the micro gap is opposed to a guide gap formed between the opposed inward flanges. The guide protrusion is slid and guided in a come-off preventing state by the inner side protrusion, so that an extremely thin fastener element can be used as the guide protrusion. While spacing of the screen fabric edge allows for movement, the use of an inner guide rail that is spaced apart allows for screen fabric wrinkles.

Applicant's U.S. patent application Ser. No. 11/326,395, entitled Retractable Screen with Horizontal Tensioning Track and Vertical Biasing Member, discloses a retractable screen fabric device for a framed opening employing a frame track fastened to each side support of the framed opening, forming a compartment. A guide rail is positioned within each compartment of each frame track extending the longitudinal length of each frame track. A decompression gasket is positioned between the frame track and the guide rail.

What is needed in the art is a screen fabric retention device using an electric motor using a slip clutch to allow additional fabric to be deployed during a wind event, when the motor remains idle.

### SUMMARY OF THE INVENTION

Disclosed is a rolling hurricane screen with an electric motor employing slip clutch for hurricane screen fabric deployment and retraction. The combination allows the electric motor to deploy and retract material, wherein the slip clutch allows the deployment of additional fabric during a high wind event.

An objective of the invention is to prevent the base slat from lifting to high wind loads.

Another objective of the invention is to disclose the use of an electric motor with a slip clutch to retain a specific amount of torque at all times, equal to or greater than the total weight of a screen fabric; the slip clutch having the ability to deploy additional fabric when the electric motor remains idle.

Yet another objective of the invention is to disclose a retention device for securing screen fabrics wherein a drive motor will not detect a change in torque, allowing the motor to operate normally. When high winds are encountered, the retention device will allow additional fabric to deploy without causing the base slat to lift. After the winds subside, the motor will rotate to return the fabric to a preset position.

Another objective of the invention is to employ a slip clutch on an electric motor to limit torque and protect mechanical components from damage due to overload or jamming.

Still another objective of the invention is to employ a slip clutch where some slippage is desirable to keep the screen fabric taunt wherein the slip clutch provides a predictable controlled way to let the motor operate without delivering full force.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1 is a perspective view of a spring loaded retention device on a rolling screen fabric;

FIG. 2 is a perspective view of a motor with a spring;

FIG. 3 is a perspective view of a spring with a tube retainer;

FIG. 4 is a perspective view of a motor with the tube retainer placed over the spring;

FIG. 5 is an end view of the spring at idle without tension;

FIG. 6 is an end view of the spring with a tube around the coil;

FIG. 7 is an end view of the spring with the tube in a retaining position;

FIG. 8 is a side view of the motor and spring, depicting the screen fabric in a high wind position;

FIG. 9 is a diagram of the fabric in an idle position and under pressure;

FIG. 10 is a diagram of the additional fabric provided by the device;

FIG. 11 is a diagram of the roller screen fabric deflection;

FIG. 12 is a perspective view of a motor with the slip clutch;

FIG. 13 is a side view of the motor and slip clutch depicting the screen fabric in a calm and a high wind position; and

FIG. 14 is an exploded view of the motor with the slip clutch and fabric roll.

### DETAILED DESCRIPTION OF THE PREFERRED EMBODIMENT

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

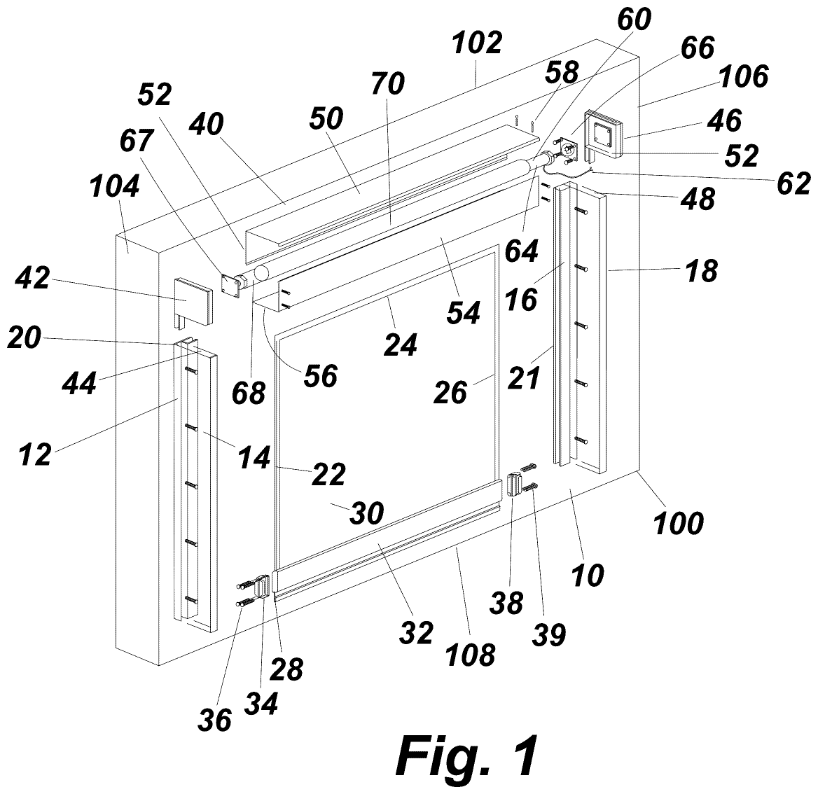

Referring to FIG. 1, illustrated is a spring loaded screen fabric retention device 10 for a framed opening 100. The framed opening is defined by a header 102, opposing side supports 104, 106, and a bottom 108. The spring loaded screen fabric retention device 10 is formed from a first side rail 12 with a first side rail cover 14 fastened to the first side support 104. A second side rail 16 with a second side rail cover 18 is fastened to the second side support 106. The first side rail 12 includes an elongated receptacle 20 constructed and arranged to receive a first side edge 22 of a flexible screen fabric 30; the second side rail 16 having an elongated receptacle 21 forming a mirror image of the first side rail 12 receptacle 20, constructed and arranged to receive a second side edge 26 of the flexible screen fabric 30.

The preferred screen fabric 30 is screen fabric material constructed of polyester threads running between the first side edge 22 and the second side edge 26 in a horizontal plane. The first and second side edges 22, 26 would include a slide mechanism which resembles a zipper element, which is constructed and arranged to slide along the elongated receptacles 20, 21; the zipper element providing a thickness to resist pulling away from the elongated receptacles 20, 21. A plurality of breaks in the zipper element allow the screen fabric material to be tightly wound for storage purposes. The preferred flexible screen fabric 30 is made of high strength polyester fibers running in both directions. The threads placed in a vertical position are interwoven with the threads placed in the horizontal position. The bottom edge 28 of the sceen is attached to an aluminum base slat 32. An end retention element 34 is secured to the base slat with fasteners 36 along the first side edge 22, and end retention element 38 is secured to the base slat 32 along the second side edge 26 with fasteners 39.

A housing 40 is secured to the upper framing member 102. The housing 40 is formed of a first end cap 42 secured to a top 44 of the first rail 12 and a second end cap 46 secured to a top 48 of the second rail 16. The housing 40 is formed by an upper panel 50 having a back side wall 52 and a lower panel 54 having a bottom side wall 56. The panels 50, 54 are secured together using fasteners 58 to form a rectangular storage box for securement of a tubular motor 60 which is electrically coupled 62 to a power source. The tubular motor 60 has a proximal end 64 coupled to a second bearing bracket 66 which is fastened to the second end cap 46; the second end cap 46 having an edge 52 for securing the second end of the housing 40 to the top 48 of the second rail 16. Similarly, the distal end 68 of the tubular motor 60 is coupled to a first bearing bracket 67 fastened to the first end cap 42, securing the tubular motor 60 to the housing 40 and first rail 12. The upper edge 24 of the screen fabric is attached to an axle 70. The motor 60 connects to the idler end of a small, but stout, spring 72. The torque transfers through the spring assembly 72 and drives a tube 80. During normal motor operations, the spring 72 remains stationary and the motor 60 moves the screen fabric up and down. When the unit is in the down position and pressures are applied, the motor 60 remains stationary and the spring 72 rotates and deploys additional screen fabric. As a result, the base slat 32 remains on the floor and does not lift up.

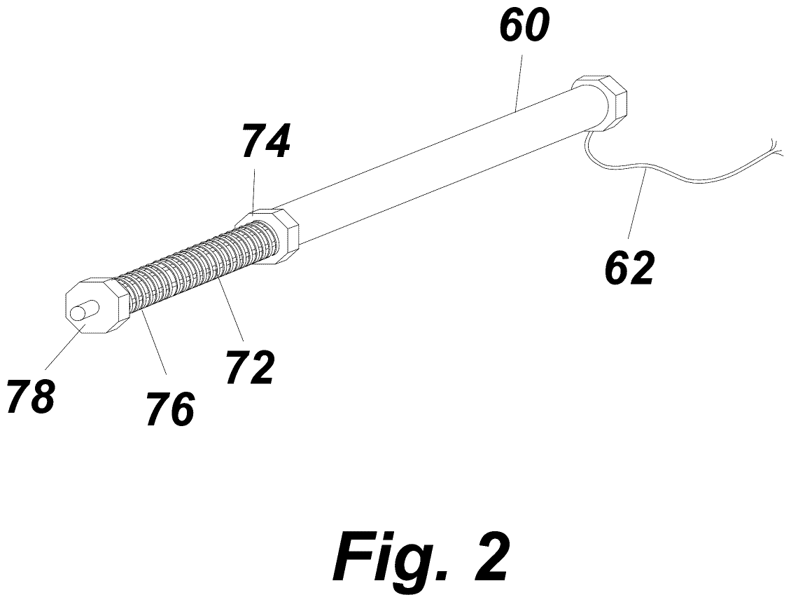

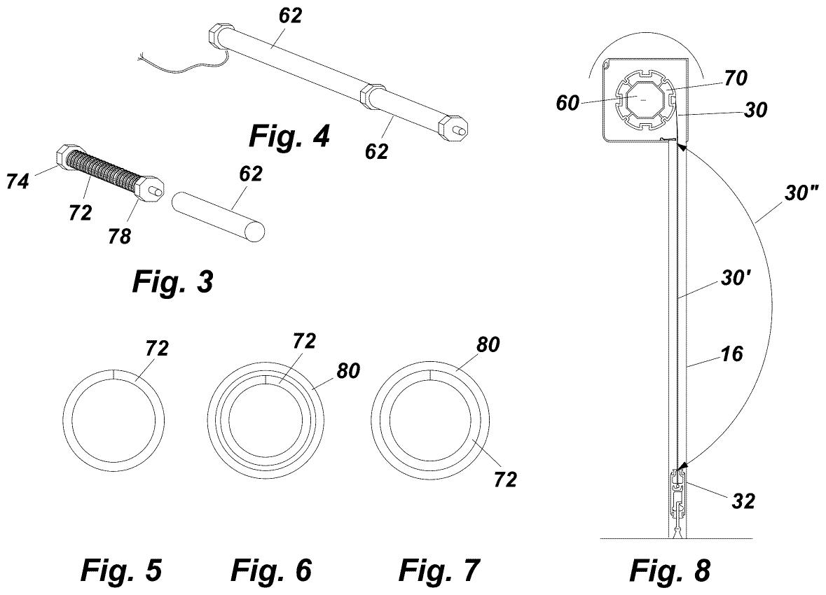

Referring to FIGS. 2-4, the tubular motor 60 employs an extension shaft 71. A coil spring 74 is positioned over the extension shaft 71 with an idler end 74 secured to the tubular motor 60 and a second end 76 attached to a drive element 78. A tube 80 is placed over the spring 72 in a coiled position for retaining spring tension. When torsion is added to the spring 72, the behavior of the spring 72 is to wrap coils tighter and tighter, wherein the coil diameter is gradually reduced. To accommodate this, torsion is added to the spring 72 (rotation), and while the coils are compressed, the tube 80 is placed around the coils. When torsion from the spring 72 (rotation) is reduced, the coils expand until they fill the inside diameter of the tube 80, therefore retaining a portion of the spring's torque. This allows the spring 72 to retain a specified amount of torque at all times, while still allowing the spring 72 to add torsion (rotation) when needed and return back to a retained state. The continuous torsion allows the motor 60 to operate normally, since the retained torsion is equal to or greater than the weight of the screen fabric 30. The end result is that the motor 60 operates normally and additional torsion is available when needed. As a result, the base slat 32 remains on the floor during times of high winds and will not lift up.

FIG. 5 is an end view of the spring 72 at idle without tension. FIG. 6 is an end view of the spring 72 with a tube 80 around the coil. The spring with tension is applied, wherein the coil diameter is reduced and the tube 80 can be placed around the spring 72. FIG. 7 is an end view of the spring 72 with the tube 80 in a retaining position. The spring 72 with relieved tension causes the coil diameter to increase and the tube 80 is retaining the spring tension.

FIG. 8 is a side view of the axle 70 with the screen fabric 30 deployed. The bottom 28 of the screen fabric 30 is attached to the base slat 32. During deployment, the screen fabric 30′ extends along the side rail 16 in a vertical format. Under high wind conditions the motor 60 remains fixed and the spring rotates to deploy additional screen fabric 30″.

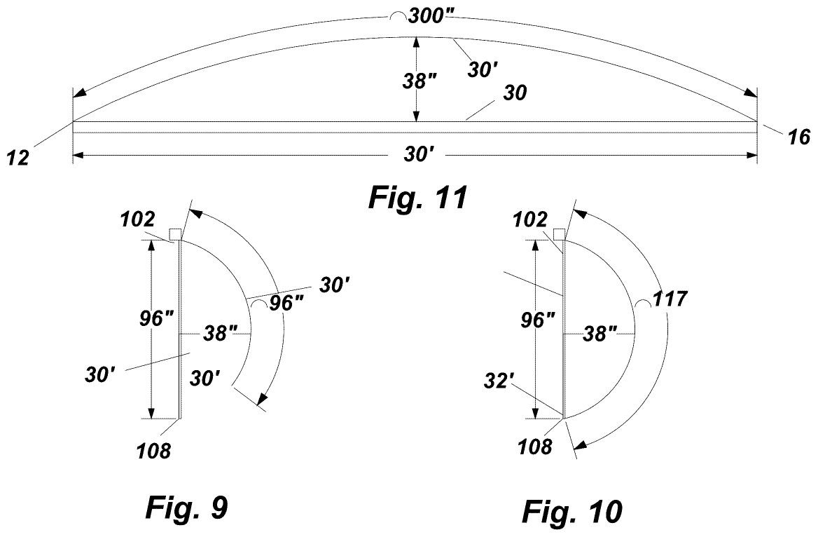

FIG. 9 depicts an example of a conventional opening wherein the distance between the bottom 108 and top 102 of the frame 100 is about 96 inches. In an idle position, the screen fabric 30 is deployed in the vertical stance. When a high wind load pressure is applied, and there is no mechanism to allow screen fabric deflection, the screen fabric 30′ deflects 38 inches causing the base slat to lift up 24 inches.

FIG. 10 depicts an example of an application wherein the distance between the bottom 108 and top 102 of the frame 100 is about 96 inches. In an idle position, the screen fabric 30 is deployed in the vertical stance. When a high wind load pressure is applied, and the spring loaded motor of the instant invention is employed, the screen fabric 30′ deflects 38 inches by drawing additional screen fabric from the axle, allowing the screen fabric to deflect but removing the pressure on the base slat 32 to keep the screen fabric secured to the floor. The tubular motor 60 allows the screen fabric 30 to wrap around the axle in a stowage position and extend the base slat 32 to the bottom in a deployed position, whereby the spring 72 allows the axle to deploy additional screen fabric under high wind condition, allowing the base slat 32 to maintain contact with the bottom 108 of the framed opening 100.

Referring to FIG. 11, the top end view depicts the screen fabric 30 in an idle position on a frame opening having a width of about 288 inches. Using a preferred screen material having high strength polyester threads interwoven in a horizontal position, the fabric 30′ can expand about 38 inches during the high wind loading. This expansion relieves the pressure on the side rails 12, 16. This is made possible as the polyester threads can stretch about 12 inches.

Calculation of the total curtain weight is necessary to size the total spring torque. In the preferred embodiment, the total spring torque is 150% of the curtain weight. Total curtain weight is calculated by adding the fabric weight, base slat weight, and additional friction weight. Once the total curtain weight is calculated the total spring torque can be estimated. Fabric weight is calculated by multiplying the width (ft) of the screen against the height (ft) of the screen. The total fabric in pounds (lbs) is calculated by multiplying the total area in square feet against the fabric in pounds per square foot to obtain the total fabric weight (lbs). The base slat weight is obtained by multiplying the unit width (ft) against the base slat weight (lbs). Additional friction weight is calculated by multiplying the unit height (ft) by the additional fiction per linear foot to obtain the total friction in pounds.

Total spring torque is calculated by taking the total curtain weight in pounds which would equal 100% of the confined spring torque. An additional spring torque of 50% is added to the total curtain weight. The preferred total spring torque range is between 100% to 150% of the curtain weight.

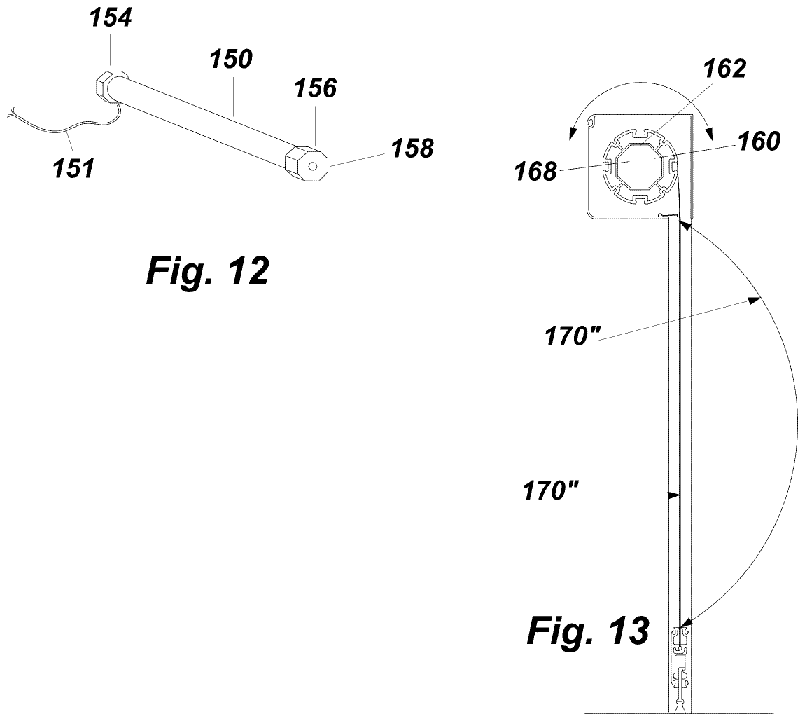

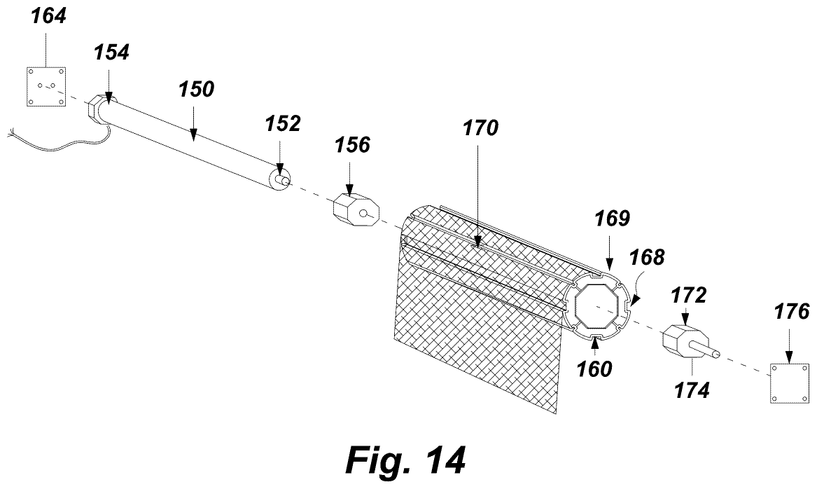

Referring to FIGS. 12 and 13, illustrated is an alternative embodiment comprising a motor 150 having a motor drive 152 on a first end and a second end 154 having motor limits. A slip clutch 156 is attached to the motor drive 152. The motor is electric for receipt of power through a power cord 151. The outer surface 158 of the slip clutch 156 having a sidewall arrangement constructed and arranged to fit within the axle 160 employing a reciprocal sidewall surface 162. The slip clutch 156 can be spring or disc. The second end 154 of the motor 150 is secured to a side wall with a motor bracket 164. The axle 160 having an outer surface 168 having receptacles 169 receiving the leading edge of the screen fabric 170. The axle 160 is slidably secured to the slip clutch 156 by engaging the sidewall surface 162 over the outer surface 158. Axle bearing 172 includes an outer surface 174 that fits within the axle 160 employing reciprocal sidewall surface 162. The axle bearing 172 allowing rotation of the axle 160 in accordance with the motor operation. The axle bearing 172 couples to a bearing bracket 176.

During heavy winds the slip clutch 156 will allow the axle 160 to rotate and deploy additional fabric 170′ as depicted in FIG. 13, while the motor drive 152 remains stationary. When the storm has past, and the motor is activated, the limit settings 154 of the motor 150 will return to their original positions and the fabric 170″ placed taunt.

Calculation of the slip clutch torque should equal the total combined weight of the screen fabric so that the motor will operate normally. Total curtain weight is calculated by adding the fabric weight, base slat weight, and additional friction weight. Once the total curtain weight is calculated the total torque can be estimated. Fabric weight is calculated by multiplying the width (ft) of the screen against the height (ft) of the screen. The total fabric in pounds (lbs) is calculated by multiplying the total area in square feet against the fabric in pounds per square foot to obtain the total fabric weight (lbs). The base slat weight is obtained by multiplying the unit width (ft) against the base slat weight (lbs). Additional friction weight is calculated by multiplying the unit height (ft) by the additional fiction per linear foot to obtain the total friction in pounds.

Total slip clutch torque is calculated by taking the total curtain weight in pounds which would equal 100% of the confined torque. An additional torque of 50% is added to the total curtain weight. The preferred total spring torque range is between 100% to 150% of the curtain weight.

The term “coupled” is defined as connected, although not necessarily directly, and not necessarily mechanically. The use of the word “a” or “an” when used in conjunction with the term “comprising” in the claims and/or the specification may mean “one,” but it is also consistent with the meaning of “one or more” or “at least one.” The term “about” means, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

All patents and publications mentioned in this specification are indicative of the levels of those skilled in the art to which the invention pertains. It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A screen fabric retention device for a framed opening having a header, opposing side supports, and a bottom, said device comprising:
a first side rail fastened to a first side support and a second side rail fastened to a second side support, each said side rail forming an elongated receptacle;
a housing having a first end secured to a top of said first side rail and a second end secured to a top of said second side rail;
a tubular motor electrically coupled to a power source, said tubular motor having a proximal end secured to said housing and a drive end coupled to stationary bearing bracket, said motor including motor limits;
an axle having an interior chamber constructed and arranged to cooperate with said tubular motor;
a slip clutch assembly operatively connected to said drive end of said tubular motor, said slip clutch assembly having an outer surface configured to fit within said axle configured to allow rotation of the axle without motor operation; and
a flexible screen fabric having a top edge attached to said axle, opposing side edges secured within said first and second side rails, and a bottom edge secured to a base slat;
wherein said tubular motor rotates said axle to wrap said screen fabric therearound in a stowage position, and to extend said screen fabric and said base slat toward the bottom of the framed opening in a deployed position wherein said slip clutch allows fabric deployment while said motor remains idle.

2. The screen fabric retention device of claim 1, wherein the axle is coupled to the housing by a bearing bracket.

3. The screen fabric retention device according to claim 1 wherein said screen fabric is rated for hurricane resistance.

4. The screen fabric retention device according to claim 1 wherein said screen fabric consists of a high strength polyester threads placed in a horizontal direction interwoven with high strength polyester threads placed in the vertical direction.

5. The screen fabric retention device according to claim 1 wherein said slip clutch torque is between 100% to 150% of the curtain weight.

6. The screen fabric retention device according to claim 1 wherein said slip clutch allows said axle to rotate and said motor to remain idle while deploying screen fabric under high winds.

7. The screen fabric retention device according to claim 6 wherein after deployment of the screen fabric, activation of said motor restores the screen fabric to pre-set motor limits.

8. The screen fabric retention device according to claim 1 wherein motor limit settings are governed by the position of said axle.

9. A screen fabric retention device for a framed opening having a header, opposing side supports, and a bottom, the device comprising:
a first side rail mounted to a first side support and a second side rail mounted to a second side support, each side rail defining an elongated receptacle;
a housing having a first end secured to a top of the first side rail and a second end secured to a top of the second side rail;
a tubular motor electrically connected to a power source, the tubular motor having a proximal end secured to the housing and a distal end coupled to a stationary bearing bracket;
an axle having an interior chamber configured to cooperate with a drive end of said tubular motor;
a slip clutch assembly operatively connected to said drive end of said tubular motor, the slip clutch assembly having an outer surface configured to fit within the axle, the slip clutch assembly being configured to allow rotation of the axle independently of the motor under predetermined torque conditions;
a flexible screen fabric having a top edge attached to the axle, opposing side edges retained within the first and second side rails, and a bottom edge secured to a base slat;
wherein the tubular motor is configured to rotate the axle to wind the screen fabric into a stowage position, and to unwind the screen fabric and extend the base slat toward the bottom of the framed opening in a deployed position, wherein the slip clutch permits the axle to rotate and deploy additional screen fabric in response to high wind conditions while the tubular motor remains idle, and wherein, after such deployment, activation of the motor restores the screen fabric to pre-set limit positions without altering the motor limit settings.
